(19) United States
(12) Patent Application Publication
(10) Pub. No.: US 2018/0075945 A1
(43) Pub. Date: Mar. 15, 2018

(54) HIGH FREQUENCY CABLE

(71) Applicant: JUNKOSHA INC., Kasama-shi (JP)

(72) Inventor: Hiromi Yasumoto, Kasama-shi (JP)

(21) Appl. No.: 15/701,531

(22) Filed: Sep. 12, 2017

(30) Foreign Application Priority Data
Sep. 15, 2016 (JP) 2016-181068
May 17, 2017 (JP) 2017-098502
Aug. 30, 2017 (JP) 2017-166221

(51) Int. Cl. H01B 7/29; H01B 7/02

(52) U.S. Cl. CPC H01B 7/292; H01B 7/02

(57) ABSTRACT

An object of the present invention is to provide a high frequency cable which may, for example, be used in a high bandwidth of 70 GHz or more and has high heat resistance.

A high frequency cable for a high bandwidth of 70 GHz or more, includes: one or a plurality of cable bodies, each of which includes a central conductor and a dielectric layer provided at an outer side of the central conductor; and an outer tube which is provided at an outer side of the cable body, in which the outer tube includes a first structure body in a helical shape and a second structure body in a helical shape, an inner diameter of the first structure body is smaller than that of the second structure body, the first structure body and the second structure body are mutually fitted in helical pitches, and each of the first structure body and the second structure body includes a material having a thermal conductivity of 9 W·m⁻¹·K⁻¹ or more, and in which in a bent state of the cable, a helix at an outer ring side of the second structure body is configured to move to an inner ring side of the second structure body so that the helix is fitted in a state of being embedded in a gap formed at an outer ring side of the first structure body and is contacted with the cable body.

### CROSS-REFERENCE TO RELATED APPLICATION

This application is based on and claims priority under 35 USC 119 from Japanese Patent Application Nos. 2016-181068, 2017-098502, and 2017-166221, filed on Sep. 15, 2016, May 17, 2017, and Aug. 30, 2017, respectively, the entire contents of which are hereby incorporated by reference.

### BACKGROUND OF THE INVENTION

### Technical Field

The present invention is applied to a high frequency cable which may, for example, be used in a high bandwidth of 70 GHz or more.

### Background Art

Patent Document 1 discloses a coaxial cable which can be used in DC (direct current) to a high bandwidth up to 110 GHz and includes a central conductor, a dielectric layer, an outer conductor layer, and a sheath. Heat resistance is insufficient in the coaxial cable in which an outer side than the above sheath is exposed to air. Comparative Example 13 to be described later proves the above problem.
Patent Document 1: Japanese Patent No. 4583201

### SUMMARY

An object of the present invention is to provide a high frequency cable which may, for example, be used in a high bandwidth of 70 GHz or more and has high heat resistance.

A high frequency cable according to the present invention includes: one cable body which includes a central conductor and a dielectric layer provided at an outer side of the central conductor; and an outer tube which is provided at an outer side of the cable body, in which the outer tube includes a first structure body in a helical shape and a second structure body in a helical shape, an inner diameter of the first structure body is smaller than that of the second structure body, the first structure body and the second structure body are mutually fitted in helical pitches, and each of the first structure body and the second structure body includes a material having a thermal conductivity of 9 W·m⁻¹·K⁻¹ or more, and in which in a bend state of the cable, a helix at an outer ring side of the second structure body is configured to move to an inner ring side of the second structure body so that the helix is fitted in a state of being embedded in a gap formed at an outer ring side of the first structure body and is contacted with the cable body.

A high frequency cable according to the present invention includes: a plurality of cable bodies, each of which includes a central conductor and a dielectric layer provided at an outer side of the central conductor; and an outer tube which is provided at an outer side of the cable body, in which the outer tube includes a first structure body in a helical shape and a second structure body in a helical shape, an inner diameter of the first structure body is smaller than that of the second structure body, the first structure body and the second structure body are mutually fitted in helical pitches, and each of the first structure body and the second structure body includes a material having a thermal conductivity of 9 W·m⁻¹·K⁻¹ or more, an in which in a bent state of the cable, a helix at an outer ring side of the second structure body is configured to move to an inner ring side of the second structure body so that the helix is fitted in a state of being embedded in a gap formed at an outer ring side of the first structure body and is contacted with the cable body.

Preferably, the outer tube may have a void ratio of 75% or less, in which the void ratio is obtained by subtracting a sectional area S2 of the cable body from an area S1 of a circle whose diameter is an inner diameter of the first structure body in a linear state to provide a difference value, and dividing the difference value by the area S1 and multiplying the obtained quotient by 100.

More preferably, the void ratio may be 68% or less. Further, more preferably, the void ratio may be less than 50%.

More preferably, a dielectric constant of the dielectric layer may be 1.8 or less, and a sum of an effective outer diameter of the central conductor and an effective outer diameter of the dielectric layer may be 2.7 mm or less.

According to the present invention, a high frequency cable which may, for example, be used in a high bandwidth of 70 GHz or more and has high heat resistance may be obtained.

### BRIEF DESCRIPTION OF THE DRAWINGS

FIG. 1 is a perspective view schematically representing a configuration of an example of the present invention.

FIG. 2 is a sectional view schematically representing the configuration of the example of the present invention.

FIG. 3A and FIG. 3B are sectional views schematically representing a configuration of an outer tube of the example of the present invention, in which FIG. 3A is a view showing a linear state and FIG. 3B is a view showing a bent state.

FIG. 4A and FIG. 4B are views schematically showing a relationship between a cable body and an outer tube in a case where the outer tube is only configured by a first structure body, in which FIG. 4A is a view showing a linear state and FIG. 4B is a view showing a bent state.

FIG. 5A and FIG. 5B are views schematically showing a relationship between a cable body and an outer tube in a case where the outer tube is configured by the first structure body and a second structure body, in which FIG. 5A is a view showing a linear state and FIG. 5B is a view showing a bent state.

FIG. 6A and FIG. 6B are views for explaining a void ratio, in which FIG. 6A is a sectional view in a longitudinal direction and FIG. 6B is a view showing a sectional view in a radial direction.

### DETAILED DESCRIPTION

Hereinafter, a high frequency cable according to the present invention will be described with reference to the drawings. However, it should be noted that the technical scope of the present invention is not limited to these embodiments, but extends to equivalents with the present invention described in the claims. In the examples and comparative examples to be shown below, one or two cable bodies are provided, but more than two cable bodies may be inserted through an outer tube.

(Configuration of High Frequency Cables According to Examples)

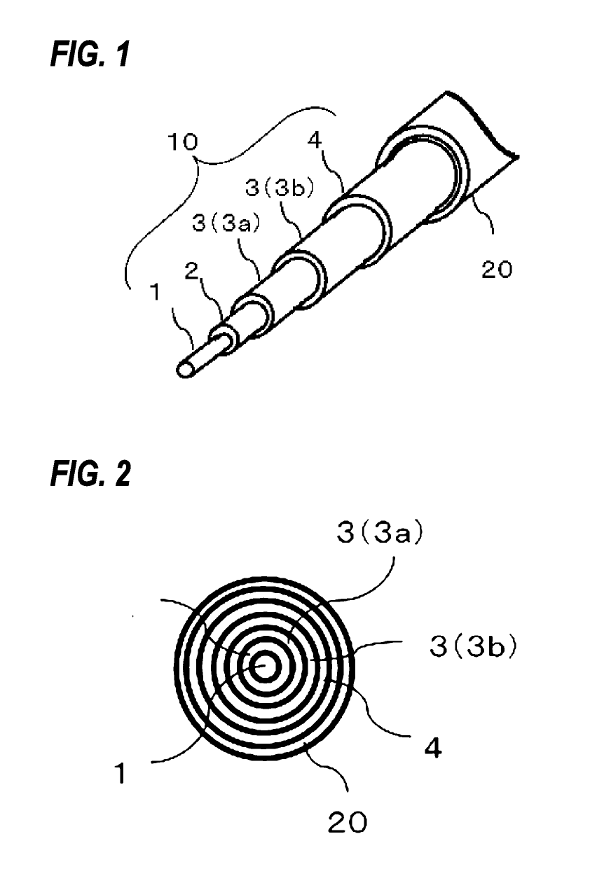

FIG. 1 and FIG. 2 are views schematically showing a configuration of a high frequency cable according to an example which schematically represents a configuration of an example of the present invention. As shown in FIG. 1, the high frequency cable according to the example includes a cable body 10 which includes a central conductor 1, a dielectric layer 2, an outer conductor 3 and a jacket (sheath) 4, and an outer tube 20 which is disposed at an outer side of the cable body 10 and whose inner circumferential surface contacts with the cable body 10. The central conductor 1 is made of a silver-plated annealed copper wire with an effective outer diameter of 0.32 mm. The dielectric layer 2 is configured to have an effective outer diameter of 0.95 mm by winding and being covered with porous polytetrafluoroethylene (hereinafter, referred to as “EPTFE” and having a dielectric constant of 1.8) in a tape shape. The outer conductor 3 is configured by a first outer conductor 3a and a second outer conductor 3b. The first outer conductor 3a is configured to have an outer diameter of 1.05 mm by winding and being covered with a silver-plated copper foil tape. The second outer conductor 3b is configured to be formed with a braided structure having sixteen spindles and four ends by using a silver-plated annealed copper wire with an outer diameter of 0.05 mm, and to have an outer diameter of 1.25 mm. The sheath 4 is extruded and covered with a tetrafluoroethylene-hexafluoropropylene copolymer (hereinafter, referred to as “FEP”) with a thickness of 0.1 mm. A final outer diameter of the cable body 10 is configured to be 1.45 mm.

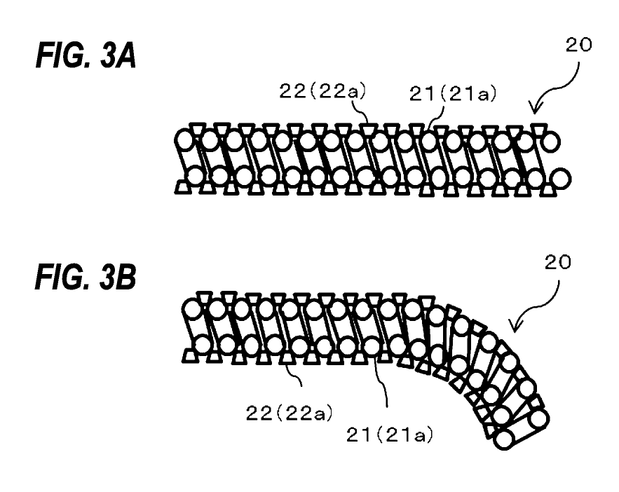

Next, a configuration of the outer tube 20 will be described by using FIG. 3A and FIG. 3B. FIG. 3A and FIG. 3B show sectional views in a longitudinal direction of the outer tube 20. As shown in the figures, the outer tube 20 has a first structure body in a helical shape and a second structure body in a helical shape. An inner diameter of the first structure body is smaller than that of the second structure body. The first structure body and the second structure body are mutually fitted in helical pitches. Each of the first structure body 21 and the second structure body 22 is made of materials having a thermal conductivity of 9 W·m⁻¹·K⁻¹ or more. The materials and thermal conductivities of the outer tube according to Examples 1 to 10 are described in Table 1 to be described later. As shown in FIG. 3B, in the bent state, the second structure body may be engaged in a state of being embedded, in a radial direction, in a gap formed at an outer ring side of the first structure body.

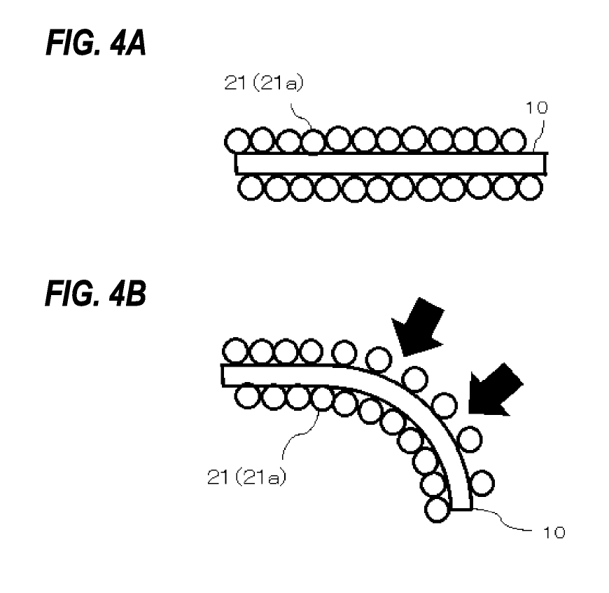

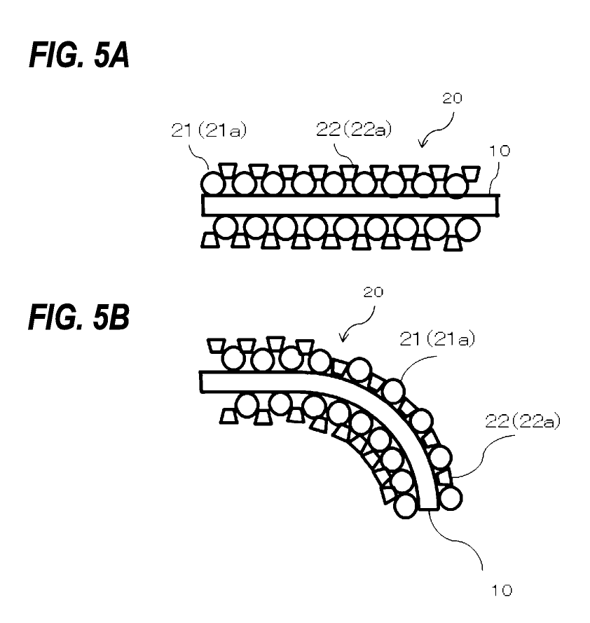

Herein, a relationship between the cable body 10 and the outer tube 20 will be explained by using FIG. 4A, FIG. 4B, FIG. 5A and FIG. 5B. As in the background art described above, in a cable body (not shown) in which an outer side than a sheath is exposed to air, only air having a poor thermal conductivity (the thermal conductivity is 0.0241 W·m⁻¹·K⁻¹) is around the cable, heat of the cable body may not be cooled down efficiently, and the cable may not be used for a long time. In this manner, regarding heat generation of the cable body, the heat is dissipated only by heat transfer due to air at the outer side of the cable, and the heat may not be dissipated efficiently in the air having the poor thermal conductivity.

In contrast, according to the present example, since the outer tube having an excellent thermal conductivity is provided near the cable body, the heat of the cable body may be dissipated efficiently by contacting the cable body with the outer tube. Since the outer tube of the example is configured by the first and second structure bodies, in bending, the second structure body is engaged, in the radial direction, in a state of being embedded in the gap formed at the outer ring side of the first structure body. Therefore, a gap is not formed on the outer tube in bending, and since the outer tube having an excellent thermal conductivity is provided near the cable body in either the linear state or the bent state, frequency of contact between the cable body 10 and the outer tube 20 is increased, and the heat of the cable body may be dissipated efficiently by contacting the cable body with the outer tube.

As shown in FIG. 4A and FIG. 4B, in a case where the outer tube only has the first structure body 21 as a configuration thereof, there is a certain degree of effect on heat dissipation of the cable body 10 by contacting the cable body 10 with the outer tube 20. However, when the cable body is bent, the first structure body 21 is also bent, gaps (arrow portions) are formed at the outer ring side, contact points between the cable body 10 and the outer tube 20 are decreased, and the heat generated from the cable may not be sufficiently cooled down, so that it is not easy to use the cable for a long time.

In contrast, FIG. 5A and FIG. 5B show an embodiment in which the second structure body 22 is adopted as a configuration of the outer tube 20. In the embodiment, compared to the outer tube only having the first structure body 21, in the bent state, the contact points between the cable body 10 and the outer tube 20 are increased and a total volume of a heat dissipation member including the first structure body 21 and the second structure body 22 is increased, so that the heat resistance (heat dissipation) of the cable is remarkably excellent.

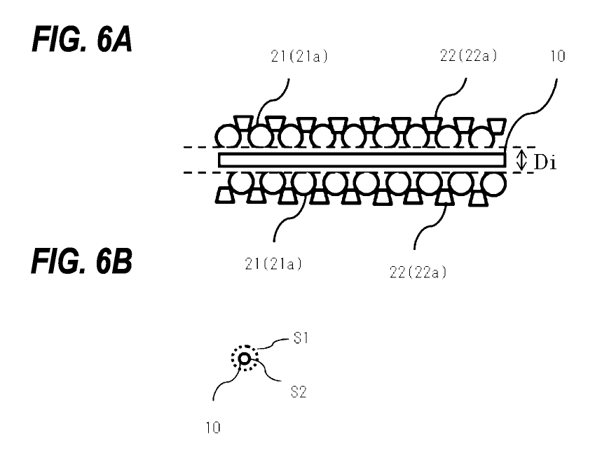

Hereinafter, results of heat resistance tests according to Examples and Comparative Examples are shown in Table 1. In Examples 1 to 16 and Comparative Examples 1 to 26, structures of the cable bodies are all the same, and structures and materials of the outer tubes and presence or absence of the outer tubes are different, respectively. Porosities of Examples 1 to 26 and Comparative Examples 1 to 26 are shown in Table 1 below. Herein, as shown in FIG. 6A and FIG. 6B, the void ratio is represented by the following equation in which a value obtained by subtracting a sectional area S2 of the cable body from an area S1 of a circle whose diameter is an inner diameter Di of the first structure body in the linear state, and dividing the difference value by the area S1 and multiplying the obtained quotient by 100.

Void Ratio (%)=(S1−S2)/S1×100

In order to obtain the excellent heat resistance (heat dissipation) of the cable, the cable body 10 may be contacted with the outer tube easily in the linear state and the bent state, and when a diameter of the cable body 10 is compared with an inner diameter of the outer tube 20, the void ratio is preferably 75% or less where the inner diameter of the outer tube 20 does not exceed two times the diameter of the cable body 10.

More preferably, the void ratio between the cable body 10 and the outer tube 20 is 68% or less, and thereby heat dissipation due to the contact between the cable body 10 and the outer tube 20 is further excellent.

More preferably, the void ratio between the cable body 10 and the outer tube 20 is less than 50%, and thereby heat dissipation due to the contact between the cable body 10 and the outer tube 20 is extremely excellent.

TABLE 1

| | Cable Body | | | | | Outer Tube | | | | |
|---|---|---|---|---|---|---|---|---|---|---|
| | | | | | | | | Thermal | Void | Heat |
| | Central | Dielectric | Outer | | | | | Conductivity | Ratio | Resistance |
| | Conductor | Layer | Conductor | Sheath | Number | Structure | Material | (W · m⁻¹ · K⁻¹) | (%) | Test |
| Example 1 | Silver- | EPTFE | Silver-Plated | FEP | 1 | First | Aluminum | 236 | 47.4 | In ten cable |
| | Plated | (※1) | Copper Foil | (※2) | | Structure | | | | bodies, |
| | Annealed | | Tape and | | | Body and | | | | dielectrics |
| | Copper | | Silver-Plated | | | Second | | | | were not |
| | Wire | | Annealed | | | Structure | | | | melted. |
| | | | Copper Wire | | | Body | | | | |
| Example 2 | Silver- | EPTFE | Silver-Plated | FEP | 1 | First | Brass | 106 | 47.4 | In ten cable |
| | Plated | (※1) | Copper Foil | (※2) | | Structure | | | | bodies, |
| | Annealed | | Tape and | | | Body and | | | | dielectrics |
| | Copper | | Silver-Plated | | | Second | | | | were not |
| | Wire | | Annealed | | | Structure | | | | melted. |
| | | | Copper Wire | | | Body | | | | |
| Example 3 | Silver- | EPTFE | Silver-Plated | FEP | 1 | First | Stainless | 16.7 | 47.4 | In ten cable |
| | Plated | (※1) | Copper Foil | (※2) | | Structure | Copper | | | bodies, |
| | Annealed | | Tape and | | | Body and | | | | dielectrics |
| | Copper | | Silver-Plated | | | Second | | | | were not |
| | Wire | | Annealed | | | Structure | | | | melted. |
| | | | Copper Wire | | | Body | | | | |
| Example 4 | Silver- | EPTFE | Silver-Plated | FEP | 1 | First | Nickel | 9.4 | 47.4 | In ten cable |
| | Plated | (※1) | Copper Foil | (※2) | | Structure | Alloy | | | bodies, |
| | Annealed | | Tape and | | | Body and | | | | dielectrics |
| | Copper | | Silver-Plated | | | Second | | | | were not |
| | Wire | | Annealed | | | Structure | | | | melted. |
| | | | Copper Wire | | | Body | | | | |
| Example 5 | Silver- | EPTFE | Silver-Plated | FEP | 2 | First | Nickel | 9.4 | 47.5 | In ten cable |
| | Plated | (※1) | Copper Foil | (※2) | | Structure | Alloy | | | bodies, |
| | Annealed | | Tape and | | | Body and | | | | dielectrics |
| | Copper | | Silver-Plated | | | Second | | | | were not |
| | Wire | | Annealed | | | Structure | | | | melted. |
| | | | Copper Wire | | | Body | | | | |
| Example 6 | Silver- | EPTFE | Silver-Plated | FEP | 7 | First | Nickel | 9.4 | 46.6 | In only one |
| | Plated | (※1) | Copper Foil | (※2) | | Structure | Alloy | | | cable body, |
| | Annealed | | Tape and | | | Body and | | | | dielectric |
| | Copper | | Silver-Plated | | | Second | | | | was melted. |
| | Wire | | Annealed | | | Structure | | | | |
| | | | Copper Wire | | | Body | | | | |
| Example 7 | Silver- | EPTFE | Silver-Plated | FEP | 1 | First | Stainless | 16.7 | 66.4 | In ten cable |
| | Plated | (※1) | Copper Foil | (※2) | | Structure | Copper | | | bodies, |
| | Annealed | | Tape and | | | Body and | | | | dielectrics |
| | Copper | | Silver-Plated | | | Second | | | | were not |
| | Wire | | Annealed | | | Structure | | | | melted. |
| | | | Copper Wire | | | Body | | | | |
| Example 8 | Silver- | EPTFE | Silver-Plated | FEP | 2 | First | Nickel | 9.4 | 66.3 | In ten cable |
| | Plated | (※1) | Copper Foil | (※2) | | Structure | Alloy | | | bodies, |
| | Annealed | | Tape and | | | Body and | | | | dielectrics |
| | Copper | | Silver-Plated | | | Second | | | | were not |
| | Wire | | Annealed | | | Structure | | | | melted. |
| | | | Copper Wire | | | Body | | | | |
| Example 9 | Silver- | EPTFE | Silver-Plated | FEP | 1 | First | Stainless | 16.7 | 74.1 | In ten cable |
| | Plated | (※1) | Copper Foil | (※2) | | Structure | Copper | | | bodies, |
| | Annealed | | Tape and | | | Body and | | | | dielectrics |
| | Copper | | Silver-Plated | | | Second | | | | were not |
| | Wire | | Annealed | | | Structure | | | | melted. |
| | | | Copper Wire | | | Body | | | | |
| Example 10 | Silver- | EPTFE | Silver-Plated | FEP | 2 | First | Stainless | 16.7 | 74.4 | In only one |
| | Plated | (※1) | Copper Foil | (※2) | | Structure | Copper | | | cable body, |
| | Annealed | | Tape and | | | Body and | | | | dielectric |
| | Copper | | Silver-Plated | | | Second | | | | was melted. |
| | Wire | | Annealed | | | Structure | | | | |
| | | | Copper Wire | | | Body | | | | |
| Comparative | Silver- | EPTFE | Silver-Plated | FEP | 1 | Only First | Nickel | 9.4 | 47.4 | In three |
| Example 1 | Plated | (※1) | Copper Foil | (※2) | | Structure | Alloy | | | cable bodies, |
| | Annealed | | Tape and | | | Body | | | | dielectrics |
| | Copper | | Silver-Plated | | | | | | | were melted. |
| | Wire | | Annealed | | | | | | | |
| | | | Copper Wire | | | | | | | |
| Comparative | Silver- | EPTFE | Silver-Plated | FEP | 1 | Only First | Stainless | 16.7 | 66.4 | In four cable |
| Example 2 | Plated | (※1) | Copper Foil | (※2) | | Body | Copper | | | bodies, |
| | Annealed | | Tape and | | | Structure | | | | dielectrics |
| | Copper | | Silver-Plated | | | | | | | were melted. |
| | Wire | | Annealed | | | | | | | |
| | | | Copper Wire | | | | | | | |
| Comparative | Silver- | EPTFE | Silver-Plated | FEP | 1 | Only First | Stainless | 16.7 | 74.1 | In seven |
| Example 3 | Plated | (※1) | Copper Foil | (※2) | | Structure | Copper | | | cable bodies, |
| | Annealed | | Tape and | | | Body | | | | dielectrics |
| | Copper | | Silver-Plated | | | | | | | were melted. |
| | Wire | | Annealed | | | | | | | |
| | | | Copper Wire | | | | | | | |
| Comparative | Silver- | EPTFE | Silver-Plated | FEP | 1 | None | — | 0.0241 | — | In ten cable |
| Example 4 | Plated | (※1) | Copper Foil | (※2) | | | | | | bodies, |
| | Annealed | | Tape and | | | | | | | dielectrics |
| | Copper | | Silver-Plated | | | | | | | were melted. |
| | Wire | | Annealed | | | | | | | |
| | | | Copper Wire | | | | | | | |

※1 porous polytetrafluoroethylene
※2 tetrafluoroethylene-hexafluoropropylene copolymer

The heat resistance tests were conducted by respectively using ten cable bodies from Examples 1 to 16 and Comparative Examples 1 to 26. A test device was used in which a high power amplifier and a directional coupler were connected to a microwave transmitter, each of the cables according to Examples 1 to 8 and Comparative Examples 1 to 13 described above was connected to the directional coupler, and a terminator was connected to each of the cables. A test method is as follows: generating and amplifying a signal, dividing the signal into two signals by the directional coupler, using one signal as an object to be measured and using the other signal for observing electric energy, and then confirming, based on whether a dielectric is melted, whether the heat resistance is present, after a constant period of time has elapsed. This result is also shown in Table 1 described above.

### DESCRIPTION OF REFERENCE NUMERALS

1 central conductor
2 dielectric layer
3 outer conductor
3 first outer conductor
3b second outer conductor
4 jacket (sheath)
10 cable body
20 outer tube
21 first structure body
21 first linear body
22 second structure body
22 second linear body

What is claimed is:

1. A high frequency cable for a high bandwidth of 70 GHz or more, comprising: one cable body which includes a central conductor and a dielectric layer provided at an outer side of the central conductor; and an outer tube which is provided at an outer side of the cable body, wherein the outer tube includes a first structure body in a helical shape and a second structure body in a helical shape, an inner diameter of the first structure body is smaller than an inner diameter of the second structure body, the first structure body and the second structure body are mutually fitted in helical pitches, and each of the first structure body and the second structure body includes a material having a thermal conductivity of 9 W·m⁻¹·K⁻¹ or more, and wherein in a bent state of the cable, a helix at an outer ring side of the second structure body is configured to move to an inner ring side of the second structure body so that the helix is fitted in a state of being embedded in a gap formed at an outer ring side of the first structure body and is contacted with the cable body.

2. A high frequency cable for a high bandwidth of 70 GHz or more, comprising: a plurality of cable bodies, each of which includes a central conductor and a dielectric layer provided at an outer side of the central conductor; and an outer tube which is provided at an outer side of the cable body, wherein the outer tube includes a first structure body in a helical shape and a second structure body in a helical shape, an inner diameter of the first structure body is smaller than an inner diameter of the second structure body, the first structure body and the second structure body are mutually fitted in helical pitches, and each of the first structure body and the second structure body includes a material having a thermal conductivity of 9 W·m⁻¹·K⁻¹ or more, and wherein in a bend state of the cable, a helix at an outer ring side of the second structure body is configured to move to an inner ring side of the second structure body so that the helix is fitted in a state of being embedded in a gap formed at an outer ring side of the first structure body and is contacted with the cable body.

3. The high frequency cable according to claim 1, wherein the outer tube has a void ratio of 75% or less, wherein the void ratio is obtained by subtracting a sectional area S2 of the cable body from an area S1 of a circle whose diameter is an inner diameter of the first structure body in a linear state to provide a difference value, and dividing the difference value by the area S1 and multiplying the obtained quotient by 100.

4. The high frequency cable according to claim 1, wherein the void ratio is 68% or less.

5. The high frequency cable according to claim 1, wherein the void ratio is less than 50%.

6. The high frequency cable according to claim 1, wherein,
a dielectric constant of the dielectric layer is 1.8 or less, and
a sum of an effective outer diameter of the central conductor and an effective outer diameter of the dielectric layer is 2.7 mm or less.
